(19) United States
(12) Patent Application Publication
(10) Pub. No.: US 2015/0053450 A1
(43) Pub. Date: Feb. 26, 2015

(54) STATOR FOR A HYDRAULIC WORK TOOL ASSEMBLY

(71) Applicant: Caterpillar Work Tools B.V, 's-Hertogenbosch (NL)

(72) Inventor: Johannes Lambertus Leonardus Van Gemert, Mill (NL)

(73) Assignee: Caterpillar Work Tools B.V, 's-Hertogenbosch (NL)

(21) Appl. No.: 14/530,846

(22) Filed: Nov. 3, 2014

(51) Int. Cl. B02C 1/00; B02C 1/02; E02F 9/22; E04G 23/08

(52) U.S. Cl. CPC B02C 1/005; E04G 23/082; B02C 1/02; E02F 9/2278
USPC 173/218

(57) ABSTRACT

A hydraulically activatable work tool assembly for a machine is provided. The work tool assembly includes a first manifold assembly, a second manifold assembly, and a stator. The second manifold assembly is structured and arranged to rotate relative to the first manifold assembly. The second manifold assembly is in fluid communication with the first manifold assembly. The stator is disposed within the second manifold assembly and defines a mounting surface structured and arranged to abut a mounting pad. The stator defines a mounting surface structured and arranged to abut a base plate frame disposed proximal to the second manifold assembly. The stator includes a channel extended from the mounting surface along an axial length of the stator. Further, a plug is sealably positioned in the channel of the stator, corresponding to the plug being in an abutment relationship with the base plate frame.

### TECHNICAL FIELD

The present disclosure relates generally to work tool assemblies. More specifically, the present disclosure relates to a stator for a hydraulic work tool assembly having at least one through channel exiting the manifold, which requires to be sealed off.

### BACKGROUND

Construction machines, such as hydraulic excavators, are equipped with highly specialized work tools, such as buckets, shovels, grippers, hammers, shears, cutters, ripper teeth, grapples, blades, pulverizers, multiprocessors, load hooks, and the like. In addition to the hydraulic excavators, wheel loaders and other construction machines with corresponding booms are customarily utilized. The optional attachment of different work tools has made it possible to utilize these construction machines as multi-function machinery. Typically, the work tool is adapted to be mounted on a rigid boom of the construction machine, particularly onto the end of the stick of the excavator. The work tools that are suitable for use with different tasks may be fitted to the stick of the construction machine. However, in demolition applications, such as handling and processing of materials (such as wood, concrete, and/or metal), the construction machine may be equipped with a multiprocessor attached to the stick by means of a coupler.

The multiprocessor is an assembly within a demolition tool and it provides the demolition tool with cutting and crushing capability. The multiprocessor includes a pair of jaws, a hydraulic cylinder, and a stator. The jaws are used to engage the material during an operation. The multiprocessor may be equipped with a wide selection of interchangeable jaws, known as concrete cutters, demolitions, pulverizers, shears, universals, and/or tank shears. With one common housing and a properly selected set of jaws, an operator may achieve flexibility to accomplish most tasks encountered on a demolition job. The demolition job is accomplished by opening and closing of the jaws actuated by the hydraulic cylinder. The hydraulic cylinder extends and retracts to close and open the jaws, respectively. Extension and refraction of the hydraulic cylinder occurs due to fluid pressures in the hydraulic cylinder. The fluid is supplied to the hydraulic cylinder via one or more hoses, which are fluidly connected to a stator attached to the mulitprocessor. The hoses are in fluid communication with a plurality of channels housed within the stator. For formation of the channels at a desired position in the stator, one or more additional bores are drilled into the stator. Upon formation of favorable channels in the stator, the one or more bores are typically closed by a threaded bolt in conjunction with an O-ring or gasket, which is sealed to its mating foundation by compression of a bolt head as is customary. These threaded bolts require the bores to be of a slightly larger diameter and to be spaced apart from one another. This works with stators of smaller multiprocessors. However, in larger demolition applications, it often requires a manufacturer to stock a larger multiprocessor, which will open and close the jaws engaging a heavy load. Widening of the fluid channels in the stator of the smaller sized microprocessor to provide increased functionality may cause space concerns and may make the bores in the stator too close together to be adequately plugged or sealed off. The present disclosure is directed to one or more of the problems discussed above.

### SUMMARY OF THE INVENTION

The present disclosure relates to a hydraulically activatable work tool assembly for a machine.

In accordance with the present disclosure, the work tool assembly includes a first manifold assembly, a second manifold assembly, and a stator. The second manifold assembly is structured and arranged to rotate relative to the first manifold assembly. The second manifold assembly is in fluid communication with the first manifold assembly. The stator is disposed within the second manifold assembly. The stator defines a mounting surface structured and arranged to abut a base plate frame disposed proximal to the second manifold assembly. The stator includes a channel extended from the mounting surface along an axial length of the stator. Further, the stator includes a plug. The plug is sealably disposed in the channel of the stator, corresponding to the plug being in an abutment relationship with the base plate frame.

### BRIEF DESCRIPTION OF THE DRAWINGS

FIG. 1 illustrates a side view of a work machine, fitted with a multiprocessor based work tool assembly, in accordance with the concepts of the present disclosure;

FIG. 2 illustrates the work tool assembly of the machine of FIG. 1, in accordance with the concepts of the present disclosure;

FIG. 3 illustrates the work tool assembly of FIG. 2, with the mounting frame removed to disclose a stator having a construct in accordance with the concepts of the present disclosure;

FIG. 4 illustrates a sectional view of the work tool assembly of FIG. 2, illustrating a sectional view of the stator of FIG. 3, in accordance with the concepts of the present disclosure;

FIG. 5 illustrates an isometric view of a stator, which is customarily mounted within the work tool assembly of FIG. 2, in accordance with the concepts of the present disclosure;

FIG. 6 illustrates an exploded, view of the stator of FIG. 5 with a portion thereof sectioned to illustrate a channel and a counterbore, which is structured to receive a plug therein, in accordance with the concepts of the present disclosure; and

FIG. 7 is a sectional view of the stator of FIG. 5 illustrating a plug sealed within the counterbore of the stator, in accordance with the concepts of the present disclosure.

### DETAILED DESCRIPTION

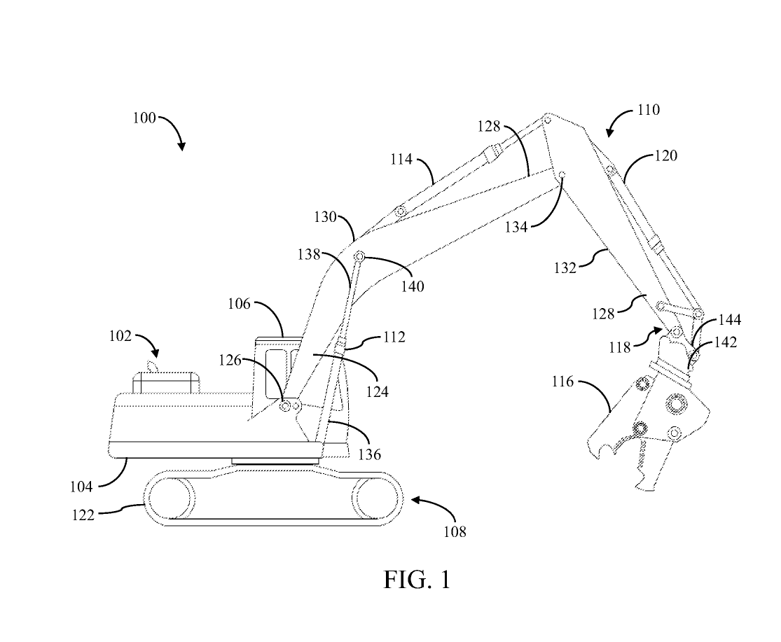

Referring to FIG. 1, there is shown a work machine or machine 100. The machine 100 is a hydraulic excavator. However, other machines with an extendable arm to accommodate transportation of a payload at the end of such an arm may also be envisioned. The machine 100 may include a car body 102, an engine (not shown), a main frame 104, a cab 106, an undercarriage assembly 108, a lift arm assembly 110, a pair of boom cylinders 112, a stick cylinder 114, a work tool assembly 116, a work tool linkage assembly 118, and a bucket cylinder 120.

The machine 100 customarily includes the car body 102, which includes the engine (not shown), to propel the machine 100. The car body 102 is mounted on the main frame 104. The main frame 104 supports the cab 106, as well as other components of the machine 100, either directly or indirectly, such as the lift arm assembly 110, the car body 102 and various hydraulic components. The main frame 104 is supported by the undercarriage assembly 108, which includes a pair of track chains 122 that engage the ground and propel the machine 100. In particular, mechanical output from the engine (not shown) is provided to a hydraulic pump/motor assembly (not shown), which uses hydraulic fluid power to drive the pair of track chains 122. Hence, the pair of track chains 122 rotate to drive an endless track chain. As the pair of track chains 122 rotate, the track chain advances and provides the motive power to the machine 100.

The cab 106 is attached to an upper middle section of the main frame 104 and is generally an enclosed structure with windows on lateral sides of the machine 100. The cab 106 includes one or more controls (often defined as operator interface devices) therein for operator control thereof. Examples of the operator interface devices (not shown) include, but are not limited to a joystick, a steering wheel, and/or a pedal (none of which are shown, but are known by those having ordinary skill). The operator interface devices (not shown) may be located at any suitable position in the cab 106 and may be operatively coupled to a lift mechanism to raise or lower the work tool assembly 116.

The lift arm assembly 110 may include a first end 124 pivotally attached to a location on the main frame 104, which is immediately in front of the cab 106 and is located at a first pivot point 126. The lift arm assembly 110 includes a second end 128, which supports the rotatable work tool assembly 116. The lift arm assembly 110 includes a boom 130 and a stick 132. An attachment between the stick 132 and the boom 130 of the lift arm assembly 110 is provided at a second pivot point 134. The boom 130 of the lift arm assembly 110 may be lifted or actuated by the pair of boom cylinders 112, with each boom cylinder 112 being attached on each side of the lift arm assembly 110. Lower ends 136 of the boom cylinders 112 are pivotally attached to the main frame 104. The lower ends 136 are positioned beneath the boom 130 of the lift arm assembly 110. An upper end 138 of the boom cylinder 112 may be pivotally mounted on the lift arm assembly 110 at a third pivot point 140. The boom cylinders 112 are hydraulic cylinders, as is customary. Expansion of the boom cylinders 112 causes the boom 130 to pivot upwardly about its respective first pivot point 126 to the main frame 104. Alternatively, retraction of the boom cylinder 112 forces the boom 130 to rotate downward about its attachment, that is, the first pivot point 126 to the main frame 104.

Further, the stick 132 is pivotally attached to a base assembly 142 of the work tool assembly 116, via the second end 128. The bucket cylinder 120 is attached to the work tool linkage assembly 118, which includes a pivot plate 144. The pivot plate 144 has a pivotable engagement with the stick 132 and a pivotable engagement with the work tool linkage assembly 118 to generally provide pivotable movement of the base assembly 142, which in return allows the work tool assembly 116 to pivot. The work tool assembly 116 may also swivel about the base assembly 142 by means of hydraulic actuation as will be described herein below. The stick 132 may be lifted or actuated by the stick cylinder 114, which extends between the boom 130 and the stick 132. The stick cylinder 114 may be an actuator, such as a hydraulic cylinder as is customary. Expansion of the stick cylinder 114 causes the stick 132 to pivot downward in a clockwise direction about the second pivot point 134. Alternatively, retraction of the stick cylinder 114 urges the stick 132 to rotate upward about the second pivot point 134.

The work tool assembly 116 may be a hydraulically activatable attachment that supports a multiprocessor unit such as a demolition tool, as exemplified in FIG. 1. The work tool assembly 116 includes the base assembly 142, which is attached to the pivot plate 144, which, in turn, is attached to the work tool linkage assembly 118. The work tool linkage assembly 118 may be coupled to the bucket cylinder 120. The bucket cylinder 120 actuates the work tool assembly 116 for clockwise and counterclockwise movement relative to the stick 132. The posture of the work tool assembly 116 may be adjusted by control of the bucket cylinder 120 and the broader control, especially raising and lowering thereof of the work tool assembly 116 may be accomplished through control of the stick cylinder 114 and the boom cylinder 112.

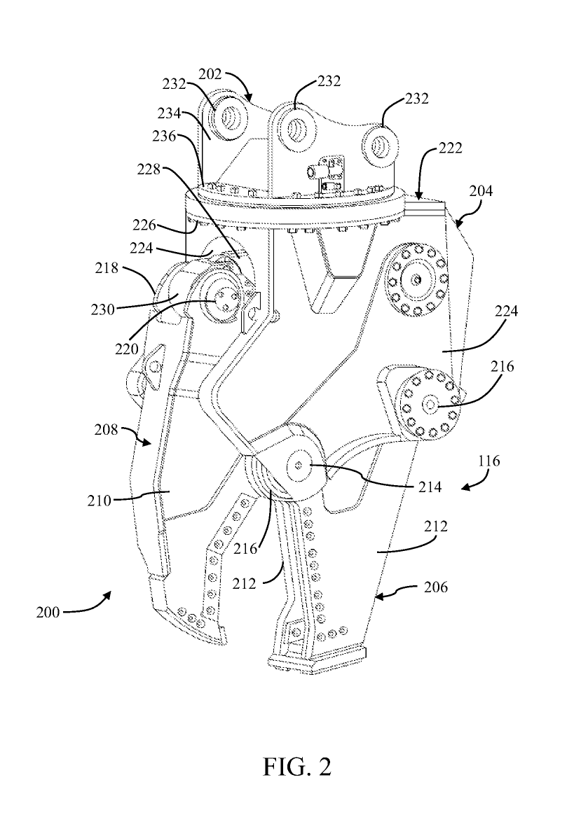

Referring to FIG. 2, there is shown the work tool assembly 116, which is a demolition tool in an exemplary embodiment. The work tool assembly 116 includes a jaw set 200, a mounting frame 202, and an adapter frame 204. The jaw set 200 includes a first jaw 206 and a second jaw 208. The first jaw 206 and the second jaw 208 are suitably provided to crush concrete and/or cut iron sections. In an embodiment, the first jaw 206 includes a first pair of plates 210, which are spaced apart and parallel. The first jaw 206 is provided with crushing or cutting tools to crush or cut activity. The crushing or cutting tools are connected to each of the first pair of plates 210 of the first jaw 206. The crushing or cutting tools are suitably configured to engage with the second jaw 208 to crush or cut material. The crushing or cutting tools may be blades, teeth, or any other form of component that is suited to cut or engage a work piece as is desired.

The second jaw 208 includes a second pair of plates 212, which are spaced-apart and parallel, similar to the first set of plates 210. The second jaw 208 is provided with crushing or cutting tools to crush or cut material. The crushing or cutting tools are connected to the second pair of plates 212 of the second jaw 208. The crushing or cutting tools are suitably configured to engage with the first jaw 206 to crush or cut material. The crushing or cutting tools may be blades, teeth, or any other form of component that is suited to cut or engage a work piece as is desired.

The first jaw 206 and the second jaw 208 are pivotally coupled by a pivot pin 214. The pivot pin 214 may extend through the first jaw 206 and into and through the second jaw 208 at the position of the pivotal connection. The pivot pin 214 may protrude from both sides of the jaw set 200. Specifically, the ends of the pivot pin 214 protrude at a rear end of the first jaw 206. Lock rings 216 may be positioned at the rear end of the first jaw 206, thereby engaging with the pivot pin 214.

The jaw set 200 further includes an actuation portion 218. The actuation portion 218 may be formed on the second jaw 208 as an extension of an end of the second jaw 208. Specifically, the actuation portion 218 may be an extension of the ends of second pair of plates 212. The actuation portion 218 may be provided with passages suitable to receive and accommodate an actuation pin 220 to couple to an actuator mechanism.

The jaw set 200 and the adapter frame 204 are mutually connectable. The adapter frame 204 includes a housing 222. The housing 222 includes a pair of frame plates 224, which are spaced apart and may be mutually parallel. The housing 222 includes a pair of frame plates 224, which are spaced apart and may define a void. The void may extend between and along the length of the pair of frame plates 224. The pair of frame plates 224 is connected to an end plate 226. The end plate 226 may be connected to the ends of the pair of frame plates 224, at an end of the housing 222, to form a limit for the void. The pair of frame plates 224 may extend perpendicularly from the end plate 226. The end plate 226 may be bound to at least two sides of the pair of frame plates 224. The sides of the pair of frame plates 224 not bound by the end plate 226, may expose the void to the exterior of the housing 222.

The housing 222 includes a cylinder 228, to pivot the second jaw 208 relative to the first jaw 206. The cylinder 228 may be positioned in the available space between the pair of frame plates 224 and adjacent to the end plate 226. The cylinder 228 includes a rod end 230 forming an eyelet as is customary. The rod end 230 may be coupled to the actuation portion 218 of the second jaw 208, via the actuation pin 220. The rod end 230 extends in a direction away from the pair of frame plates 224 and the housing 222, thereby moving the second jaw 208 towards the first jaw 206. Similarly, the rod end 230 retracts in a direction towards the pair of frame plates 224 and the housing 222, thereby moving the second jaw 208 away from the first jaw 206.

The adapter frame 204 is coupled to the mounting frame 202 in such a manner that the adapter frame 204 is rotatable (e.g., swivels) relative to the mounting frame 202. As best shown in FIG. 1 and FIG. 2, the mounting frame 202 has a pair of slots 232 on each pair of flange-shaped coupling mounts 234 and a mounting end plate 236. As shown in FIG. 1, the work tool linkage assembly 118 couples the work tool assembly 116 to the stick 132, via a pair of coupling mounts 234.

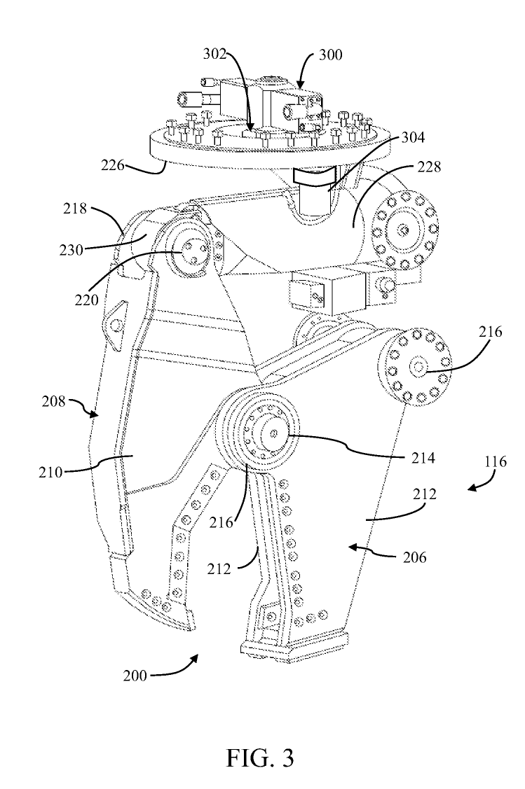

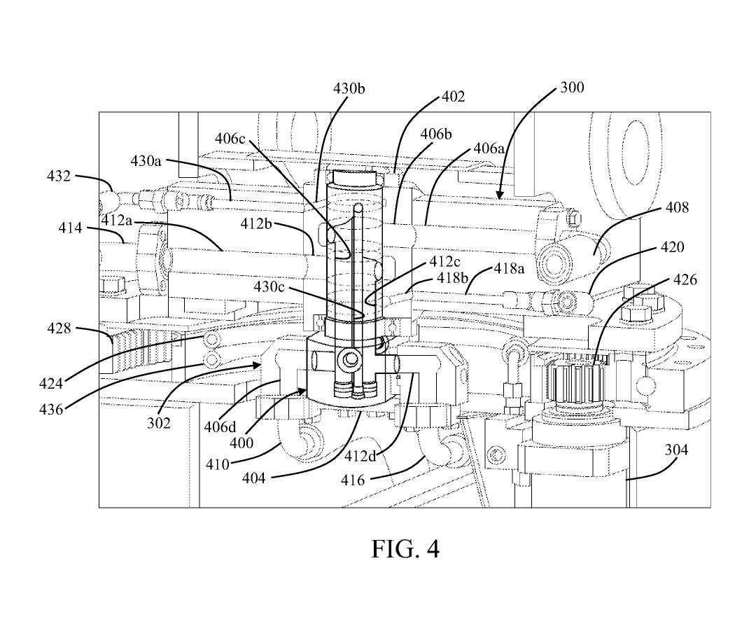

Referring to FIG. 3, there is shown the work tool assembly 116 without the housing 222 (shown in FIG. 2) and the mounting frame 202 (shown in FIG. 2) to better illustrate a first manifold assembly 300 and a second manifold assembly 302. The work tool assembly 116 includes the first manifold assembly 300, the second manifold assembly 302, and a hydraulic motor 304. The first manifold assembly 300 is mounted to the mounting frame 202 (shown in FIG. 2). The first manifold assembly 300 is in fluid communication with a source of pressurized hydraulic fluid (not shown), which may be provided within a hydraulic fluid tank (not shown) within the machine 100, as is customary. The source of pressurized hydraulic fluid is connected to the first manifold assembly 300, via a plurality of fluid fittings (shown as 408, 414, 420, and 432 in FIG. 4).

As best shown in FIG. 4, the first manifold assembly 300 is mounted, however in a manner to allow full and continuous rotation relative to the second manifold assembly 302, via a stator 400 and a rotor 402. The stator 400 is in an abutment relationship with a mounting pad 404. The second manifold assembly 302 is positioned in the vicinity to the end plate 226 of the mounting frame 202 (shown in FIG. 2) and is in fluid communication with the pair of hydraulic motors 304 (shown in FIG. 3), which rotatably drives the work tool assembly 116 relative to the mounting frame 202, as described herein below.

The hydraulic fluid, which routes through the work tool assembly 116, primarily flows through the first manifold assembly 300, the stator 400, and the second manifold assembly 302. The hydraulic fluid is then routed downstream to the cylinder 228 to open/close the second jaw 208 relative to the first jaw 206. Further, the hydraulic fluid is also routed to the hydraulic motors 304 to drive the direction of swivel of the work tool assembly 116.

A jaw close passage is composed of sub-channels, starting with a channel 406a provided in the first manifold assembly 300, which is fluidly connected upstream to a first fitting 408 connected to tank (not shown, however may be a source of pressurized hydraulic fluid). The first fitting 408 is in fluid communication with the tank of the machine 100. Flow of the hydraulic fluid from the machine 100 to the first fitting 408 may be controlled by a direction control valve (not shown). The first fitting 408 delivers hydraulic fluid to the channel 406a. The channel 406a in the first manifold assembly 300 is connected to a channel 406b within the rotor 402 and then extends through to a channel 406c, which extends along the length of the stator 400. The channel 406c then connects to a channel 406d, which is formed within the second manifold assembly 302. The channel 406d is connected to a first hose fitting 410, which is fluidly connected to the head end of the cylinder 228 of the work tool assembly 116 (FIG. 3). Hence, the channel 406d is in fluid communication with the head end of the cylinder 228, via the first hose fitting 410. During closing operation of the jaw set 200, the head end of the cylinder 228 is pressurized. The hydraulic fluid flows from the tank (not shown) to the head end of the cylinder 228, serially, via the first fitting 408, the channel 406a, the channel 406b, the channel 406c, the channel 406d, and the first hose fitting 410. The flow of the hydraulic fluid increases pressure in the head end of the cylinder 228. Simultaneously, the hydraulic fluid from the rod end 230 of the cylinder 228 is free flow to the tank (not shown) of the machine 100, thereby causing the rod to extend and closing the second jaw 208.

A jaw open passage is composed of sub-channels, starting with a channel 412a provided in the first manifold assembly 300, which is fluidly connected upstream to a second fitting 414 in fluid communication with the tank (not shown, however may be a source of pressurized hydraulic fluid) of the machine 100. The channel 412a in the first manifold assembly 300 is connected to a channel 412b within the rotor 402. The channel 412b is in fluid communication with a channel 412c, which extends along the length of the stator 400. The channel 412c then connects to a channel 412d which is formed within the second manifold assembly 302. The channel 412d is connected to a second hose fitting 416, which is in fluid communication with the rod end 230 of the cylinder 228 of the work tool assembly 116 (FIG. 3). During opening of the jaw set 200, the rod end 230 of the cylinder 228 is pressurized. The hydraulic fluid flows from the tank (not shown) to the rod end 230 of the cylinder 228, serially, via the second fitting 414, the channel 412a, the channel 412b, the channel 412c, the channel 412d, and the second hose fitting 416. Simultaneously, the hydraulic fluid exits the head end of the cylinder 228 and is free flow back to the tank (not shown) of the machine 100. The hydraulic fluid flows from the head end of the cylinder 228 to the tank (not shown), serially, via the first hose fitting 410, the channel 406d, the channel 406c, the channel 406b, the channel 406a, and the first fitting 408. The flow of the hydraulic fluid from the cylinder 228 to the machine 100, reduces the pressure in the head end of the cylinder 228 and causes the rod to contract and open the first jaw 206.

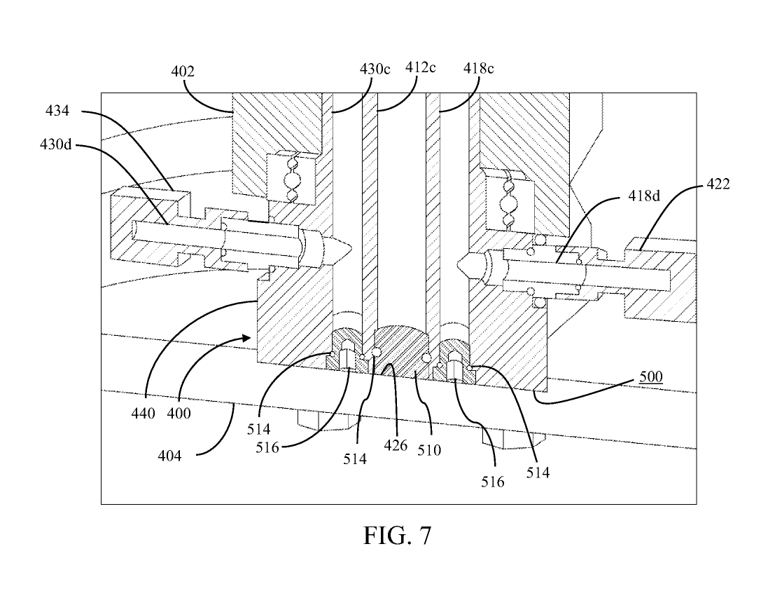

A first passage and a second passage are designed to control the clockwise rotation and the counterclockwise rotation of the hydraulic motor 304. Rotation of the hydraulic motor 304 swivels the work tool assembly 116 in clockwise direction and counterclockwise direction, based on the rotation of the hydraulic motor 304. The first passage is composed of sub-channels, starting with a channel 418a provided in the first manifold assembly 300. The channel 418a is fluidly connected to a third fitting 420. Flow of the hydraulic fluid from the machine 100 to the third fitting 420 may be controlled by the direction control valve (not shown). The channel 418a in the first manifold assembly 300 is connected to a channel 418b within the rotor 402 and then extends through to a channel 418c (FIG. 7), which extends along the axial direction of the stator 400. The channel 418c then connects to a channel 418d (FIG. 7), which is formed within the second manifold assembly 302. The channel 418d is connected to a third hose fitting 422 (FIG. 7), which is, in turn, fluidly connected to a first hose 424. The first hose 424 is in fluid communication with the hydraulic motor 304.

In an embodiment, the hydraulic fluid from the machine 100, is directed to the hydraulic motor 304, serially, through the third fitting 420, the channel 418a, the channel 418b, the channel 418c, the channel 418d, the third hose fitting 422, and the first hose 424. The hydraulic fluid delivered by the first hose 424 actuates the hydraulic motor 304. Actuation of the hydraulic motor 304 may cause a drive gear 426 thereof to drive a ring gear 428, and work tool assembly 116, in the clockwise direction or the clockwise direction.

A second passage is composed of sub-channels, starting with channel 430a provided in the first manifold assembly 300. The channel 430a is fluidly connected to a fourth fitting 432, which is in fluid communication with the tank (not shown, however may be a source of pressurized lubricant or hydraulic fluid). The channel 430a in the first manifold assembly 300 is connected to a channel 430b within the rotor 402. The channel 430b is in fluid communication with a channel 430c (FIG. 7), which extends along in the axial direction of the stator 400. The channel 430c then connects to a channel 430d (FIG. 7), which is formed within the second manifold assembly 302. The channel 430d is connected to a fourth hose fitting 434 (FIG. 7), which is, in turn, fluidly connected to a second hose 436. The second hose 436 is in fluid communication with the hydraulic motor 304. The hydraulic fluid is routed from the hydraulic motor 304 to the machine 100, serially, via the second hose 436, the fourth hose fitting 434, the channel 430d, the channel 430c, the channel 430b, the channel 430a, and the fourth fitting 432.

In an embodiment, the second passage may be adapted to deliver the hydraulic fluid from the machine 100 to the hydraulic motor 304, serially, via the fourth fitting 432, the channel 430a, the channel 430b, the channel 430c, the channel 430d, and the fourth hose fitting 434. Further, the first passage may be adapted to route the hydraulic fluid from the hydraulic motor 304 to the machine 100, serially, via, the first hose 424, the third hose fitting 422, the channel 418d, the channel 418c, the channel 418b, the channel 418a, and the third fitting 420.

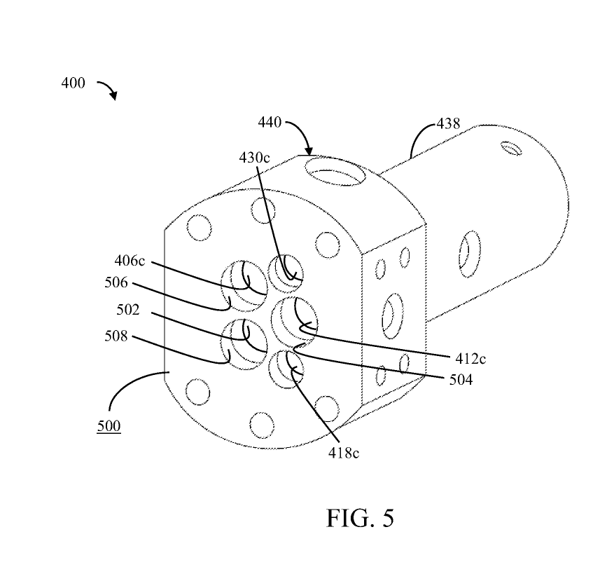

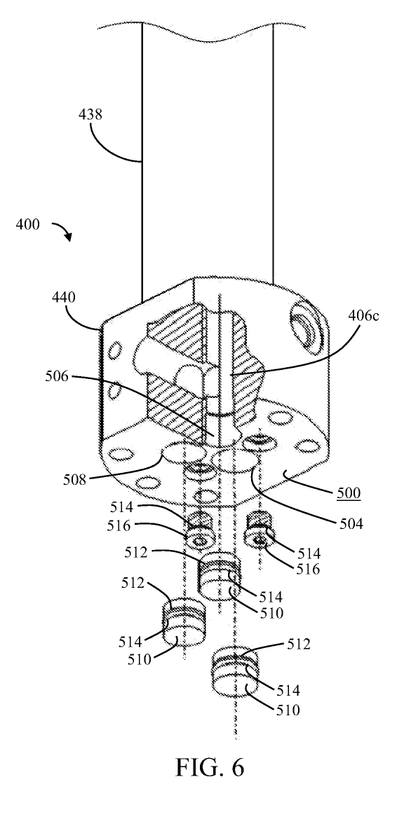

Referring to FIG. 5 and FIG. 6, a structure for blocking or sealing off channels, according to the present disclosure, will be discussed. There is shown the stator 400 disassembled from the rotor 402 of the work tool assembly 116. The stator 400 includes a shaft portion 438, which is rotatably sealed within the rotor 402 (FIG. 4) and a head portion 440, which is coupled to the second manifold assembly 302 (FIG. 4). The stator 400 has a mounting surface 500, which abuts a base plate frame 442 (FIG. 4 and FIG. 7) when assembled with the base plate frame 442. Within the mounting surface 500 of the stator 400 are three larger sized channels, namely 412c, 406c, and 502. The channel 502 is structured, similar to the channel 406c. This implies that the channel 502 is adapted to allow flow of the hydraulic fluid from the machine 100 to the head end of the cylinder 228, serially, via the first manifold assembly 300, the stator 400, and the second manifold assembly 302.

Further, there are two small sized channels 418c and 430c, within mounting surface 500 of the stator 400. It will be understood that each of the three larger channels: 412c, 406c, and 502 have counterbores. Specifically, the channel 412c is provided with a first counterbore 504; the channel 406c is provided with a second counterbore 506; and the channel 502 is provided with a third counterbore 508. Each counterbore is sized slightly larger than its corresponding channel to facilitate being sealed by a plug 510 fitted with an O-ring 514. Specifically, and as best shown in FIG. 6, each of the first counterbore 504, the second counterbore 506 and the third counterbore 508 are each fitted with the plug 510. It may be seen that each plug 510 has an O-ring groove 512, which corresponds to facilitate the O-ring 514 fitted therein. In contrast, the small sized channels 430c and 418c are each fitted with a fastening element 516, each of which may be threaded and fitted with the O-ring 514. The O-ring 514 is placed directly under the head of each fastening element 516 and made to seal with a countersink feature within each of the channels 430c and 418c when the fastening element 516 is tightened.

It will be understood that the channels 406c, 412c, 502, 418c, and 430c, which are formed typically by a drilling process within the stator 400 are deep passages that would be difficult to form other than through a drilling process. Therefore, subsequent to the channels being drilled, the ends of the channels must be plugged to suitably seal the mounting surface 500 of the stator 400. It will be further understood that the large channels 406c, 412c, and 502 may be arranged closely together without requiring the necessary space associated with providing threaded holes to close off such channels. Therefore, certain hydraulic work tool assemblies may be manufactured from smaller sized stators and as a result a common combination of the stator 400 and the rotor 402 may be used across a wider range of work tool assemblies, making this combination of the stator 400 and the rotor 402 more versatile and less expensive.

### INDUSTRIAL APPLICABILITY

In operation, the hydraulic fluid is delivered from the machine 100 to the work tool assembly 116 to control the movement of the work tool assembly 116. The plurality of fittings (shown as 408, 414, 420, and 432 in FIG. 4) delivers the hydraulic fluid from the tank (not shown) within the machine 100, to the first manifold assembly 300 of the work tool assembly 116. The first manifold assembly 300 is in fluid communication with the stator 400 and delivers the hydraulic fluid to the stator 400. The stator 400 is equipped with the plugs 510, which are configured to be fitted in each of the first counterbore 504, the second counterbore 506, and the third counterbore 508. The plugs 510 are structured to block the channels 412c, 406c, and 502. The plug 510 is in an abutment relationship with the mounting pad 404. The plug 510 is held in place inside each of the first counterbore 504, the second counterbore 506, and the third counterbore 508, due to the press-fit of the mounting surface 500 on the mounting pad 404. The mounting pad 404 is bolted to the stator 400, which provides a press-fit to the plug 510 against the mounting pad 404.

The existing stators have passages, which are typically closed by a threaded bolt in conjunction with a sealing ring. These threaded bolts require the channels to be of a slightly larger diameter and be spaced apart from one another. This works well with stators of small work tool assemblies. However, in large work tool assemblies, the larger channels and space requirements mean that a new larger stator is required. The disclosed stator 400 has an advantage over existing designs. The stator 400 includes the plugs 510, to close the channels 406c, 412c, and 502. Therefore, the stator 400 does not require much space. Hence, the present disclosure solves the space constraint concerns when there is a need for modification of the stator 400 for heavy-duty applications.

Accordingly, this disclosure includes all modifications and equivalents of the subject matter recited in the claim appended hereto as permitted by applicable law. Moreover, any combination of the described elements in all possible variations thereof is encompassed by the disclosure unless otherwise indicated herein.

One skilled in the art will realize the disclosure may be embodied in other specific forms without departing from the disclosure or essential characteristics thereof. The foregoing embodiments are therefore to be considered in all respects illustrative rather than limiting of the disclosure described herein. Scope of the invention is thus indicated by the appended claim, rather than the foregoing description, and all changes that come within the meaning and range of equivalence of the claim are therefore intended to be embraced therein.

What is claimed is:

1. A hydraulically activatable work tool assembly for a machine, the work tool assembly comprising:
a first manifold assembly;
a second manifold assembly structured and arranged to rotate relative the first manifold assembly, the second manifold assembly being in fluid communication with the first manifold assembly;
a stator disposed within the second manifold assembly, the stator defining a mounting surface structured and arranged to abut a base plate frame disposed proximal to the second manifold assembly, the stator including a channel extended from the mounting surface along an axial length of the stator; and
a plug, wherein the channel of the stator being structured and arranged to sealably receive the plug and to seal the channel within the stator corresponding to the plug being in an abutment relationship with the base plate frame.
